(19) United States
(12) Patent Application Publication
(10) Pub. No.: US 2022/0399196 A1
(43) Pub. Date: Dec. 15, 2022

(54) A SHIELD DEVICE FOR A RADIATION WINDOW, A RADIATION ARRANGEMENT COMPRISING THE SHIELD DEVICE, AND A METHOD FOR PRODUCING THE SHIELD DEVICE

(71) Applicant: Ametek Finland Oy, Espoo (FI)

(72) Inventors: Heikki Johannes SIPILÄ, Espoo (FI); Esa KOSTAMO, Helsinki (FI); Pekka TÖRMÄ, Espoo (FI)

(21) Appl. No.: 17/774,706

(22) PCT Filed: Nov. 11, 2019
(86) PCT No.: PCT/FI2019/050799

§ 371 Date: May 5, 2022

(51) Int. Cl. H01J 47/00

(52) U.S. Cl. CPC H01J 47/004

(57) ABSTRACT

A shield device (100) is for covering a radiation window (502). The shield device (100) includes a support structure (102) with an opening (106), and a flexible foil (104) covering at least the opening (106) of the support structure (102). The foil (104) includes carbon nanotubes in a form of a network (202) and the foil (104) is configured to allow radiation to pass through the foil (104) at least partly and to prevent objects (302) to pass through the foil (104). A radiation arrangement (500) includes a shield device (100), and a method is for producing a shield device (100) for a radiation window (502).

### TECHNICAL FIELD

The invention concerns in general the technical field of radiation applications. Especially the invention concerns shield devices for radiation windows.

### BACKGROUND

A radiation window is a part of a measurement apparatus, e.g. a radiation detector arrangement, that allows a desired part of electromagnetic radiation, e.g. X-ray radiation, to pass through. A radiation detector unit typically comprises a housing with an opening and the radiation window arranged to cover the opening of the housing. The radiation under study is directed through the radiation window to detector elements, e.g. one or more sensor elements, arranged within the housing and the incoming radiation may be detected with the detector elements. A chamber formed inside the housing of the radiation detector arrangement is typically either a vacuum or filled with low pressure inert gas. Typically, the radiation window is gastight in order to prevent gases entering the chamber and maintain a controlled atmosphere within the chamber.

In order to cause as little absorption as possible of the desired radiation, a major part of the radiation window should consist of a thin foil with dimensions applicable in the application area. However, if the radiation window is very thin, it may be damaged or broken, if a foreign object, e.g. a particle caused by impurity or a sample of interest, contacts the radiation window, e.g. hits the radiation window.

For example, in a beginning of a venting procedure of the chamber of the radiation detector arrangement, the pressure may be low and the particles may achieve a high velocity and travel substantially long distances. The high velocity that the particles may achieve may be even as high as the speed of sound. If the particles travelling with the high velocity hit the thin radiation window, the radiation window will be damaged or broken. Alternatively, if the radiation window is arranged very close to the sample during the measurement event, the sample may hit the thin radiation window and damage or break the radiation window.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a shield device, a radiation arrangement, and a method for producing a shield device for covering a radiation window. Another objective of the invention is that the shield device, the radiation arrangement, and the method for producing a shield device for covering a radiation window enable providing a simple and durable shield device for the radiation window and improve prevention of damaging and/or breaking of the radiation window.

The objectives of the invention are reached by a shield device, a radiation arrangement, and a method as defined by the respective independent claims.

According to a first aspect, a shield device for covering a radiation window is provided, wherein the shield device comprising: a support structure with an opening, and a flexible foil covering at least the opening of the support structure, the foil comprises carbon nanotubes in a form of a network and the foil is configured to allow radiation to pass through the foil at least partly and to prevent objects to pass through the foil.

The network of the carbon nanotubes may be a randomly aligned network comprising a plurality of apertures between randomly aligned carbon nanotubes.

The foil may be adapted to stretch due to impact of the objects in order to prevent the objects pass through the foil.

The thickness of the foil may be between 40 nanometers and 100 nanometers.

The foil may be attached to the support structure with an adhesive-based attachment solution.

The foil may further comprise a flexible base layer on which the network of the carbon nanotubes may be produced.

The base layer may be made of polyimide or parylene, wherein the thickness of the base layer may be between 50 nanometers and 1 micrometer.

Alternatively, the base layer may be made of pyrolytic carbon, Chemical Vapor Deposition (CVD) diamond, boron carbide, or silicon nitride, wherein the thickness of the base layer may be between 20 nanometers and 200 nanometers.

According to a second aspect, a radiation arrangement is provided, wherein the radiation arrangement comprising: a housing with an opening, a radiation window covering the opening of the housing, and a shield device described above arranged to cover the radiation window for preventing objects contacting the radiation window.

The shield device may be arranged at a distance (D) from the radiation window, wherein the distance (D) may be between 0.2 mm and 1 mm, preferably the distance (D) may be 0.5 mm.

The shield device may be attached to a rim of the radiation window with adhesive-based attachment solution.

Alternatively, the shield device may be removably attachable to the housing with an adapter element.

According to a third aspect, a method for producing a shield device for a radiation window is provided, wherein the method comprises: preparing a flexible foil comprising carbon nanotubes in a form of a network, and attaching the foil to a support structure with an adhesive-based attachment solution.

The preparing of the foil may comprise providing the network of carbon nanotubes on a flexible base layer.

The method may further comprise attaching a combined structure comprising the foil and the support structure to an adapter element the support structure facing to the adapter element.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1A illustrates schematically a top view of an example shield device according to the invention.

FIG. 1B illustrates schematically a cross sectional view of an example shield device according to the invention.

FIG. 2 illustrates an example of a network of carbon nanotubes of a foil according to the invention.

FIG. 3 illustrates schematically an example of a function of a shield device according to the invention.

FIG. 4 illustrates schematically a cross sectional view of another example shield device according to the invention.

FIG. 5 illustrates schematically a cross sectional view of an example radiation arrangement according to the invention.

FIG. 6 illustrates schematically a cross sectional view of another example radiation arrangement according to the invention.

FIG. 7 illustrates schematically a cross sectional view of another example radiation arrangement according to the invention.

FIG. 8 illustrates schematically an example of a method according to the invention.

FIG. 9 illustrates schematically another example of a method according to the invention.

### DESCRIPTION OF THE EXEMPLIFYING EMBODIMENTS

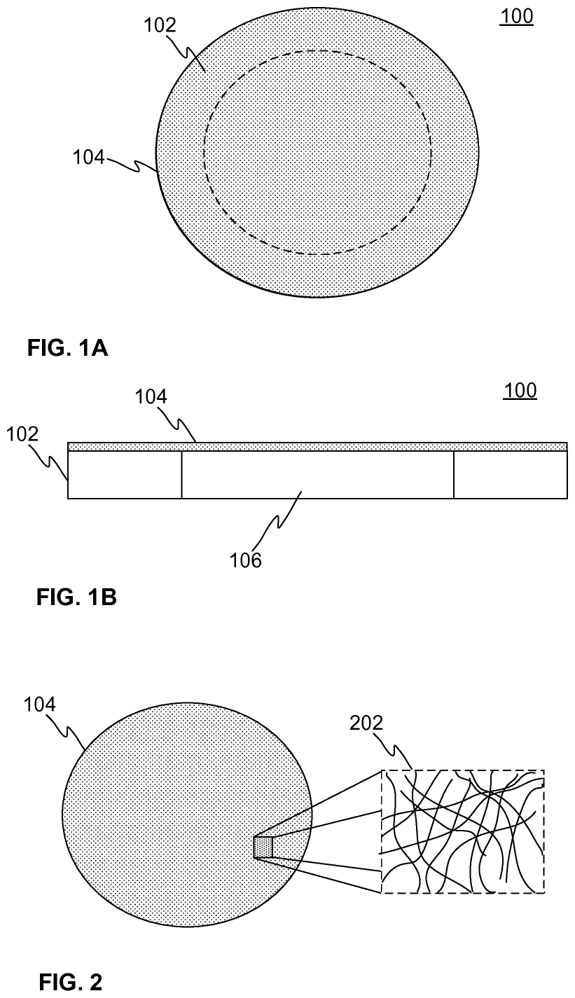

FIGS. 1A and 1B illustrate schematically an example of a shield device 100 according to the invention. FIG. 1A is a top view of the shield device 100 and FIG. 1B is a cross sectional view of the shield device 100. The dimension illustrated in Figures of this application are not to scale and not comparable to each other; they have been selected only for graphical clarity in the drawings. The shield device 100 comprises a support structure 102 with an opening 106 and a flexible foil 104 covering at least the opening 106 of the support structure 102.

The foil 104 comprises carbon nanotubes in a form of a network 202. FIG. 2 illustrates a simple example of the network 202 of the carbon nanotubes of the foil 104. FIG. 2 illustrates a micrograph of a small part of the network 202 of carbon nanotubes. The carbon nanotubes are randomly aligned in the foil 104 causing that the network 202 of the plurality of carbon nanotubes is a randomly aligned network. This can be seen in FIG. 2, wherein the nanotubes are illustrated with the black curves. The network 202 comprises a plurality of apertures between the randomly aligned carbon nanotubes. These apertures may be seen in FIG. 2 as the empty areas between carbon nanotubes. Because the carbon nanotubes are randomly aligned the plurality of apertures between the carbon nanotubes have random shapes. The diameters of the carbon nanotubes may be at nanometer scale causing that the carbon nanotubes are long in comparison to the thickness of the carbon nanotubes. The size of the plurality of apertures between the plurality of carbon nanotubes is order of tens of nanometers. Because of the nanometer scale size of the carbon nanotubes, the network 202 of the carbon nanotubes may be distinguished only microscopically, and macroscopically the foil 104 appears to be homogenous. The thickness of the foil 104 may preferably be between 40 nanometers and 100 nanometers.

The network 202 of carbon nanotubes enables that the foil 104 is configured to allow desired radiation, e.g. X-ray radiation, to pass through the foil 104. The transparency of the carbon nanotubes for the X-ray radiation is substantially good and the foil 104 has a low density, thus enabling that the foil 104 causes substantially small absorption of the X-ray radiation. The density of the network 202 of carbon nanotubes forming the foil 104 may be one third or even less of the density of a uniform carbon foil having the same thickness as the foil 104. The transparency of the carbon nanotubes for the X-ray radiation may depend at least on the thickness of the foil 104 and/or density of the foil 104. When the density decreases the transparency of the carbon nanotubes increases causing that the absorption of the X-ray radiation of the foil 104 decreases. Because the density of the foil 104 comprising the network 202 of carbon nanotubes is smaller than the density of the uniform carbon foil having the same thickness, the transparency of the foil 104 comprising the network 202 of carbon nanotubes for the X-ray radiation is better than the transparency of the uniform carbon foil for the X-ray radiation. Thus, also the absorption of the X-ray radiation of the foil 104 comprising the network 202 of carbon nanotubes is smaller than the absorption of the X-ray radiation of the uniform carbon foil.

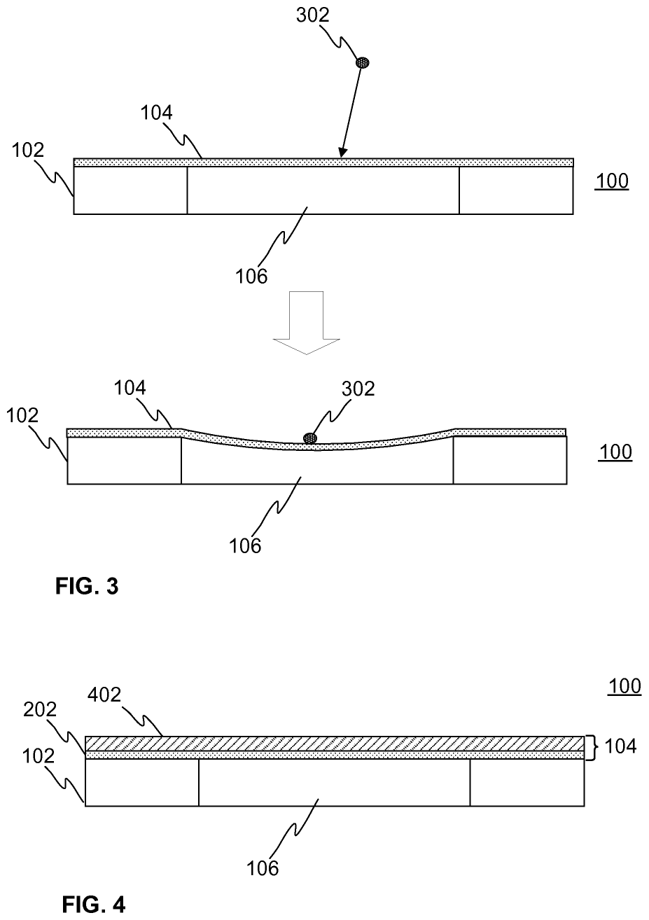

Because of the flexibility of the foil 104, the foil 104 is adapted to stretch when one or more objects 302 contact the foil 104, i.e. the foil 104 receives the one or more objects 302. The one or more objects 302 may contact, e.g. hit, the foil 104 one at a time or two or more objects at a time. The one or more objects 302 may be foreign, i.e. external, objects e.g. particles caused by impurity or the sample of interest. The particles caused by impurity may be for example dust particles. The diameter of the particles may typically be between 0.1 micrometers and 1 micrometer. The function of the shield device 100, especially the function of the flexible foil 104 of the shield device 100, is discussed next referring to FIG. 3. FIG. 3 illustrates cross sectional views of the shield device 100. In the first phase of FIG. 3 one object 302 is approaching the shield device 302. In the second phase of FIG. 3 the object 302 has reached the foil 104, i.e. contacted the foil 104, and the foil 104 is adapted to stretch due to an impact of the object 302. Because of the flexibility of the foil 104, the energy of the object 302 may be transferred to the foil 104 causing the stretching of the foil 104, which in turn causes that the foil 104 stops the movement of the object 302. Thus, the flexibility the foil 104 enables that the foil 104 is configured to prevent the objects 302 to pass through the foil 104.

A non-limiting example of a flexible foil 104 suitable for the shield device 100 may be Carbon NanoBud® film (CNB film) by Canatu. The CNB film comprising carbon nanotubes is flexible and has substantially good transparency for the X-ray radiation.

According to an embodiment of the invention, the foil 104 may further comprise a flexible base layer 402 on which the network 202 of the carbon nanotubes may be produced. The base layer 402 is flexible in order to maintain the flexibility of the foil 104. FIG. 4 illustrates schematically an example of the shield device 100, wherein the foil 104 comprises the flexible base layer 402. FIG. 4 is a cross sectional view of the shield device 100. The foil 104 comprising also the based layer 402 in addition to the network 202 of the carbon nanotubes may be attached to the support structure 102 so that the network 202 of the carbon nanotubes is facing to the support structure 102. This enables that the foil 104 withstands pressure, i.e. the foil 104 is pressure resistant. If the pressure resistance of the foil 104 is not necessary, the foil 104 comprising the network 202 of carbon nanotubes and the based layer 402 may be attached to the support structure 102 so that the carbon nanotubes is facing to the support structure 102 or so that the network 202 of the carbon nanotubes is facing to the support structure 102. The base layer 402 may be made of e.g. polyimide or parylene, wherein the thickness of the base layer may be between 50 nanometers and 1 micrometer. Alternatively, if the foil 104 is required to be vacuum-tight, the base layer 402 may be made of pyrolytic carbon, Chemical Vapor Deposition (CVD) diamond, boron carbide, or silicon nitride, wherein the thickness of the base layer 402 may be between 20 nanometers and 200 nanometers, in order to enable the flexibility of the base layer 402.

The support structure 102 may preferably be annular structure, e.g. ring, disk, collar or washer, having the opening 106 in the middle. The term “annular” should be understood in a wide sense. The invention does not require the support structure 102 to have e.g. a circular form. It is sufficient that the support structure 102 offers some edges and/or a region around the opening 106, to which the foil 104 may be attached extensively enough to keep the foil 104 in the completed structure securely in place. In FIG. 1A, wherein the top view of the shield device 100 is illustrated, the substantially annular shape of the support structure 102 is highlighted with the dashed line representing an inner edge, i.e. rim, of the support structure 102. The inner rim of the support structure 102 defines the opening 106 of the support structure 102. The thickness of the support structure 102 may be between 0.2 millimeters and 1 millimeter. The support structure may be made of e.g. steel, aluminum, or silicon. The foil 104 may be attached, i.e. secured, to the support structure 102 with adhesive-based attachment solution, e.g. using an adhesive, such as tape, glue and/or any other adhesive. The diameter of the foil 104 may be substantially the same as an outer diameter of the support structure 102 as in the examples illustrated in Figures. Alternatively, the diameter of the foil 104 may be smaller than the outer diameter of the support structure 102, but larger than the inner diameter of the support structure 102, i.e. the diameter of the opening 106 of the support structure 102, in order to enable the attachment of the foil 104 to the support structure 102. The foil 104 may cover the whole support structure 104 as illustrated in Figures, but it not necessary to cover the whole support structure 104. It is sufficient that the foil 104 covers at least the opening 106 of the support structure 102.

The shield device 100 according to the invention described above may be arranged to a radiation arrangement 500 for covering a radiation window 502 of the radiation arrangement 500 from external objects 302, e.g. particles caused by impurity or a sample of interest. In other words, the shield device 100 may be arranged to the radiation arrangement 500 to prevent the objects 302 contacting the radiation window 502 and thus the shield device 100 is configured to prevent damaging and/or breaking of the radiation window 502 due to the objects 302. As discussed in the background section of this application, for example during the venting procedure of the chamber the particles caused by impurity may travel with a high velocity even up to the speed of sound towards the radiation window 502.

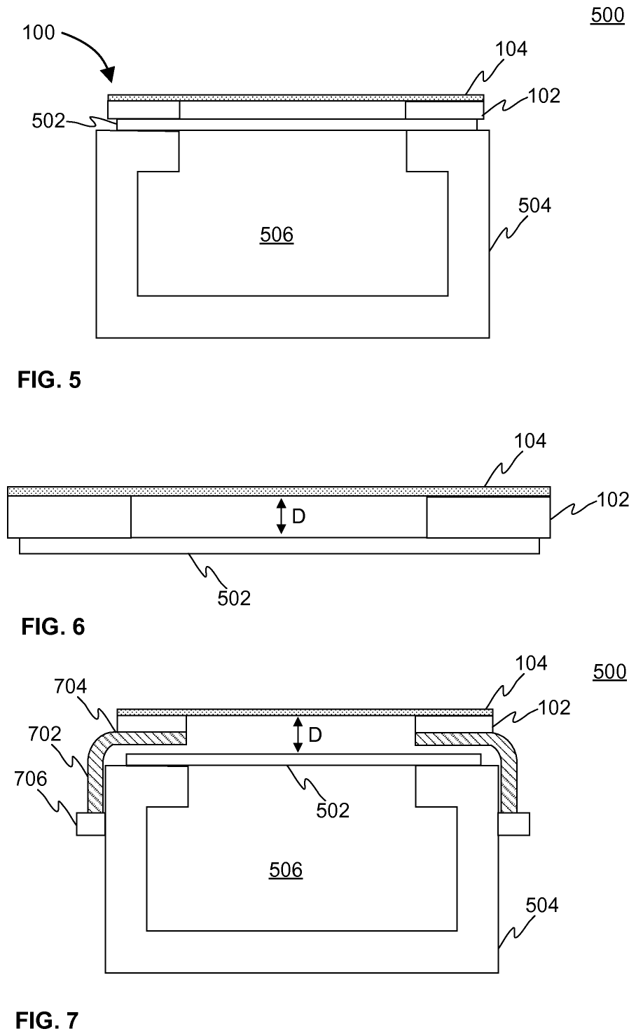

FIG. 5 illustrates schematically an example of the radiation arrangement 500 according to the invention. FIG. 5 is a cross sectional view of the radiation arrangement 500. The radiation arrangement 500 may be for example, but not limited to, an X-ray fluorescence (XRF) spectrometer or a radiation detector. The radiation arrangement 500 comprises a housing 504 with an opening, the radiation window 502 covering the opening of the housing 504, and the shield device 100 described above. The radiation arrangement 500 may further comprise detector elements, e.g. one or more sensor elements, (not shown in FIG. 5) arranged within the housing 504 for detecting incoming radiation.

In order to cause as little absorption as possible of the desired radiation, a major part of the radiation window 502 should consist of a thin foil with dimensions applicable in the application area. The thickness of the radiation window 502 may be, but not limited to, e.g. between 20 nm and 200 nm. The radiation window 502 may comprise for example, but not limited to, silicon nitride, boron carbide, boron, or beryllium. The material of the housing 504 may be for example, but not limited to, kovar, nickel, zirconium or stainless steel. A chamber 506 formed inside the housing 504 of the radiation arrangement 500 may be a vacuum or filled with low pressure inert gas. The radiation window 502 may be gastight in order to prevent gases entering the chamber 506 and to maintain a controlled atmosphere within the chamber 506 inside the housing 504.

The shield device 100 may be arranged to the radiation arrangement 500 so that the foil 104 is at a distance D from the radiation window 502. The distance D may be between 0.2 millimeters and 1 millimeter, preferably the distance D may be 0.5 millimeters. The distance D between the foil 104 of the shield device 100 and the radiation window 504 may be preferably defined such that distance D is greater than a maximum stretch of the foil 104. The material of the foil 104 defines the maximum stretch of the foil 104. In other words, the maximum stretch of the foil 104 may be defined by the maximum stretch of the network 202 of the carbon nanotubes. If the foil 104 comprises the base layer 402, the maximum stretch of the foil 104 may be defined by the maximum stretch of the base layer 402. As foil 104 allows gases, such as helium, to penetrate, i.e. to pass through the foil 104, substantially quickly, air does not remain between the foil 104 and the radiation window 502.

FIG. 6 illustrates schematically an example of the radiation arrangement 500 according to an embodiment of the invention, wherein the shield device 100 is attached to a rim, i.e. edge, of the radiation window 502 with an adhesive-based attachment solution, e.g. using an adhesive, such as tape, glue and/or any other suitable adhesive. For sake of clarity the housing 504 of the arrangement is not shown in FIG. 6. The shield device 100 may be attached to the radiation window 502 with the support structure 102 facing towards the radiation window 502. The shield device 100 is attached to the radiation window 502 on the opposite side of the radiation window 502 than the housing 504. In this embodiment the thickness of the support structure 102 of the shield device 100 defines the distance D between the foil 104 and the radiation window 502.

Alternatively, the shield device 100 may be removably attachable to the housing 504 of the radiation arrangement 500. The shield device may comprise an adapter element 702 for removably couple the shield device 100 to the housing 504 of the radiation arrangement 500. FIG. 7 illustrates schematically an example of the radiation arrangement 500 according to an embodiment of the invention, wherein the shield device 100 is removably attachable to the housing 504 of the radiation arrangement 500 with the adapter element 702. FIG. 7 is a cross sectional view of the radiation arrangement 500. The example adapter element 702 of FIG. 7 is a hollow substantially cylindrically shaped structure comprising a cover 704 with an opening at its first one end. The shield device 100 may be attached to the outer surface of the cover 704 of the adapter element 702 with an adhesive-based attachment solution, e.g. using an adhesive, such as tape, glue and/or any other suitable adhesive. The shield device 100 may be attached to the outer surface of the cover 704 with the support structure 102 facing towards the cover 704 of the adapter element 702. The diameter of the opening of the cover 702 of the adapter element 702 may be at least the same as the diameter of the opening 106 of the support structure 102 of the shied device 100.

The inner diameter of the adapter element 704 at its second end is at least slightly bigger than an outer diameter of the housing 504 so that the adapter element 702 of the shield device 100 may be fitted around the housing 504. The second end of the adapter element 702 is opposite to the first end of the adapter element 702. The adapter element 704 may be adjusted around the housing 504 at a desired location, in which the foil 104 of the shield device 100 is the distance D from the radiation window 502. The adapter element 704 may be adjusted at the desired location with a press fit, an interference fit and/or friction fit.

Alternatively or in addition, the housing 504 may comprise a bracket 706, e.g. ring, collar or similar, travelling around an outer surface of the housing 504, on which the second end of the adapter element 702 of the shield device 100 may be adjusted as illustrated in FIG. 7. The bracket 706 may be arranged at a desired location, in which the foil 104 of the shield device 100 is the distance D from the radiation window 502.

FIG. 7 illustrates only one non-limiting example of the shape of the adapter element 702 and the adapter element 702 may have any other shape suitable for removably attaching the shield device 100 to the housing 504. Preferably, a shape of the housing 504 and/or the radiation window 502 defines the shape of the adapter element 702 and also the shape of the shield device 100. For example, if the housing 504 is substantially cylindrically shaped and the radiation window 502 is substantially circular shaped, the adapter element 704 may also be substantially cylindrical shaped and the shield device 100 may be substantially circular shaped.

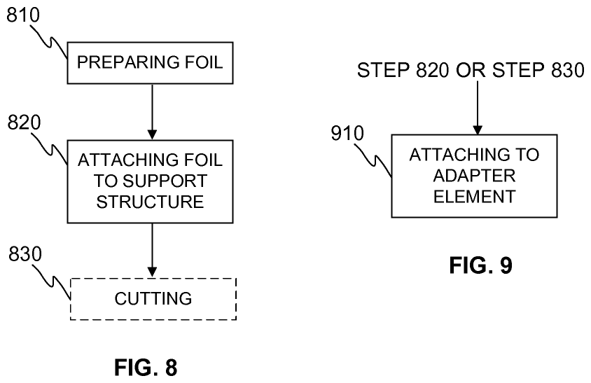

The invention relates also to a method for manufacturing at least one shield device 100 described above. FIG. 8 illustrates an example of the method according to the invention as a flow diagram. At the step 810 the flexible foil 104 comprising carbon nanotubes in the form of the network 202 is prepared. The preparing may comprise one or more steps for making the foil 104 ready to be attached. At the step 820 the foil 104 is attached to the support structure 102 with an adhesive-based attachment solution, e.g. using an adhesive, such as tape, glue and/or any other adhesive to produce the shied device 100 described above.

The preparing of the foil 104 at the step 810 may comprise cutting or trimming the foil 104 into a workpiece suitable to be attached to the support structure 102. The workpiece of the foil 104 may be cut or trimmed from a larger sheet. At the step 820 the workpiece of the foil 104 is attached to the support structure 102. From one larger sheet a plurality of workpieces of the foil 104 may be cut and each of the plurality of workpieces of the foil 104 may be attached to a respective support structure 102 for producing a plurality of sheet devices 100.

Alternatively, at the step 820 the foil 104 may be attached to the support structure 102 so that first a larger sheet of the foil 104 is attached to the support structure. Finally, the sheet of the foil 104 attached to the support structure 102 is cut or trimmed into suitable sized piece, which is illustrated at the optional dashed step 830 in FIG. 8. This enables that a plurality of support structures 102 may be attached to one sheet of the foil 104 and cut or trimmed into suitable sized pieces for producing a plurality of sheet devices 100 from one larger sheet of foil 104.

Alternatively or in addition, the preparing of the foil 104 at the step 810 may further comprise providing the network 202 of carbon nanotubes on the base layer 402 as discussed above referring to FIG. 4. When the foil 104 comprises the base layer 302, the foil 104 is attached at the step 820 to the support structure 102 so that the base layer 402 is facing to the support structure 102.

According to an embodiment of the invention illustrated in FIG. 9, the method may further comprise attaching at the step 910 a combined structure comprising the foil 104 and the support structure 102 to the adapter element 702 so that the support structure 102 is facing to the adapter element 702. This enable removable attachment of the shield device 100 to the housing 504 of the radiation arrangement 500 as discussed above referring to FIG. 7.

The specific examples provided in the description given above should not be construed as limiting the applicability and/or the interpretation of the appended claims. Lists and groups of examples provided in the description given above are not exhaustive unless otherwise explicitly stated.

1. A shield device for covering a radiation window, the shield device comprising:
a support structure with an opening, and
a flexible foil covering at least the opening of the support structure, the foil comprises carbon nanotubes in a form of a network and the foil is configured to allow radiation to pass through the foil at least partly and to prevent objects to pass through the foil.

2. The shield device according to claim 1, wherein the network of the carbon nanotubes is a randomly aligned network comprising a plurality of apertures between randomly aligned carbon nanotubes.

3. The shield device according to claim 1, wherein the foil is adapted to stretch due to impact of the objects in order to prevent the objects from passing through the foil.

4. The shield device according to claim 1, wherein a thickness of the foil is between 40 nanometers and 100 nanometers.

5. The shield device according to claim 1, wherein the foil is attached to the support structure with an adhesive-based attachment solution.

6. The shield device according to claim 1, wherein the foil further comprises a flexible base layer on which the network of the carbon nanotubes is produced.

7. The shield device according to claim 6, wherein the base layer is made of polyimide or parylene, wherein a thickness of the base layer is between 50 nanometers and 1 micrometer.

8. The shield device according to claim 6, wherein the base layer is made of pyrolytic carbon, Chemical Vapor Deposition (CVD) diamond, boron carbide, or silicon nitride, wherein a thickness of the base layer is between 20 nanometers and 200 nanometers.

9. A radiation arrangement comprising:
a housing with an opening,
a radiation window covering the opening of the housing, and
the shield device according to claim 1 arranged to cover the radiation window for preventing objects from contacting the radiation window.

10. The arrangement according to claim 9, wherein the shield device is arranged at a distance from the radiation window, wherein the distance is between 0.2 mm and 1 mm.

11. The arrangement according to claim 9, wherein the shield device is attached to a rim of the radiation window with adhesive-based attachment solution.

12. The arrangement according to claim 9, wherein the shield device is removably attachable to the housing with an adapter element.

13. A method for producing a shield device for a radiation window, wherein the method comprises:
preparing a flexible foil comprising carbon nanotubes in a form of a network, and
attaching the foil to a support structure with an adhesive-based attachment solution.

14. The method according to claim 13, wherein the preparing of the foil comprises providing the network of carbon nanotubes on a flexible base layer.

15. The method according to claim 13, further comprising attaching a combined structure comprising the foil and the support structure to an adapter element, the support structure facing to the adapter element.

16. The arrangement according to claim 9, wherein the shield device is arranged at a distance of 0.5 mm from the radiation window.
